(19) United States
(12) Patent Application Publication
(10) Pub. No.: US 2003/0075878 A1
(43) Pub. Date: Apr. 24, 2003

(54) Fixing system for cord-like elastic sealing elements

(76) Inventors: Ralf Sehr, Losheim (DE); Reimund Philippi, Schwalbach-Elm (DE); Christian Kast, Britten (DE)

Correspondence Address: James C Wray, Suite 300, 1493 Chain Bridge Road, McLean, VA, 22101, US

(21) Appl. No.: 10/258,914

(22) PCT Filed: May 3, 2001
(86) PCT No.: PCT/DE01/01675

(30) Foreign Application Priority Data
May 19, 2000 (DE) 100-24-567.6

(51) Int. Cl. F16J 15/02

(52) U.S. Cl. 277/630

(57) ABSTRACT

The invention relates to a method and a fixing system for clamping elastic rubber sealing elements, also in the form of hollow chamber profiles on thin-walled supports, for example, chassis sheet metal or other sheet metals with a 3-D external skin contour. Sealing elements, serve in particular on motor vehicles for sealing, damping, gap-filling and similar. A known or related type of clip (1) is arranged on one side of the support (2), with sealing element (4) and clamp strip (3) on the opposite side thereof, such that the fixing is achieved by means of aligned holes on the support, sealing element and clamp strip, through each of which a clip is inserted with the expanding arms pushed through, whereupon the expanding arms lock out and the clip in the opposing clamp strip (3) is thus arranged on a sealing element or within the hollow chamber of a sealing element as a one-piece whole or multi-piece components with a contour fitted to the 3D form of the relevant fixing section. In the fitted state a contiguous pressure is exercised by the clamp strip, by means of the clips on the intermediate regions lying between the support and sealing, element which guarantees a high sealing quality with good design.

The invention concerns a method corresponding to the features of the preamble of claim 1 as well as a mounting system for use with the aforementioned method in accordance with the features of the preamble of claim 6.

In fastening elastic elements, for example, sealing elements on the outer skin-like 3D shaped elements of motor vehicles, the spatial curvatures of the thin walled sheets, which serve as support, give rise to considerable problems. This is true in respect to the reproducibility of the mounting precision of the gradient on the support as well as with reference to the inherent sealing quality. A good seal quality is nonetheless a precondition for sealing, damping, filling cracks, or for comparable purposes. Regarding the sealing quality, this was attained with known adhesion technology methods under which, nevertheless, the reproducibility of the mounting on the support has suffered and repercussions on the design were additional negative consequences. The mounting quality is, therefore, a seal of quality of the installation methods with all known disadvantages of the adhesive process, especially in mass production.

Without using the adhesive technology, there are basically two known mechanical fastening systems and the associated methods, clip installation, and clip strip installation.

Fastening undertaken according to the clip installation method are characterized in that the elastic element to be fastened is fixed using one or more clips, whereby the clips as a rule have specific distances from one another. For the application in which the elastic sealing element is designed as a hollow chamber profile, the clip is the mounting element, which affects the fastening. Nonetheless, it is to be viewed as especially disadvantageous that no sufficient mounting force between sealing element is built up between the individual fastening points of the clips (not even with relatively tightly set mounting sites) and thus, no sufficient contour fitting to sharp curvatures corresponding to the automobile body contour is attainable either.

Based on the function, it will continue to be concern that, depending on the type of load, a tilting of the sealing element from its anticipated function zone could occur.

A plastic clip for blind fastening of hollow chamber profiles of elastic material on a thin-wall support as well as a method for sub-installation of the clips on a hollow chamber profile is known from DE 195 00 231 A1. Related to it, the plastic chip consists of a guide shaft at the end of which retaining straps are arranged standing opposed at their end to one another and arranged at about right angles to the guide shaft are two clamping bars (pointing v-shaped from the guide shaft in the direction of the retaining strap). The guide shaft here is designed as a thin plate with parallel lateral surfaces. The retaining straps are arranged exactly symmetrically along the longitudinal axis of the guide shaft in any given case through spreading pegs (projecting v-shaped from the lateral surfaces) on the one hand and the clamping pegs on the other.

A plastic clip is known on the basis of EP 0 526 782 A1 for blind fastening of soft elastic flat elements on support plates with two spreading fingers which can be inserted through a fastening hole of the sealing mat and shaft halves arranged at right angles and bend stretch resistant which, in the as received condition, still project outwardly, and are connected with each other on the opposite bend edges over a swivelling bar.

In the case of installation by clip strip, the elastic element to be mounted is fastened with a clip strip on the support, for example, a motor vehicle part, whereby the clip strip consists of several clips which are connected by means of a connection strip. Clips and connection strip thus form a material unit, the clip strip, which under certain circumstances is adapted or could be adapted to the contour curve of the support.

In this way, the procedural advantage is desired, that a constant fit on the support to which a contouring of the elastic element contributes by using the clip strip, be attained.

An advantageous design of the fastening system in the aforementioned type nonetheless does not remain without disadvantageous repercussions on the installation process for hollow chamber profiles, since a pre-assembly in the hollow chamber profile is possible only with difficulty, if not completely ruled, out due to the height of the chip strip. The consequence is that the economic subassembly of the clip strip and the hollow chamber profile is given only when, in addition to the hollow chamber, an additional support area freely accessible from the outside is planned for the clip strip. Furthermore, a tipping of the sealing element out of its specified function zone may occur.

A mounting strip for a seal is known from DE 196 52 459 A1, especially as an application installation for motor vehicle doors which are used for holding and positioning a seal, whereby the retaining strip has fastening devices, especially on mobile contour elements of the application facility and which has spring tongues proceeding from the equipment for connecting of the seals. An easily manufactured retaining strip, moreover, consists of a continuous band of plastic material with a meander-like top view, whereby the band forms spring segments running basically across the longitudinal extension of the retaining strips as well as pegs connecting adjacent segments. Here, the fastening equipment on the bars is arranged on the one side of the retaining strip while the spring tongues are formed from the segments as well as the bars on the other side of the retaining strip. The fastening equipment is designed as bore holes and the band consists of polyoxymethylene (POM).

U.S. Pat. No. 3,309,817 describes a sealing strip made of rubber material, which is used in metallic door openings, for example automobile doors. The sealing strip is fastened to the vehicle body by means of a non-metallic support part and also by fastening parts. In the base of the sealing strip a hollow chamber is incorporated in the longitudinal axis, which holds the support part and which in the assembled state is clamped to the vehicle body by the support part.

The creation of an additional hollow chamber for holding the support part is technically complex. Apart from the sealing area, which assumes the actual sealing function, the sealing strip requires an additional fastening area. This causes the volume required by the sealing strip to be large. Additionally, the risk of the sealing strip tilting out of its functional zone exists due to the large distance of the sealing area from the vehicle body.

Therefore, the purpose of the invention is to improve known fastening systems with its noted disadvantages, such that an economical, installation-friendly mechanical mounting of rubber elastic sealing elements, especially cord-like hollow chamber profiles which, if need be, are also to be supplemented with molded elements according to the degree of complication of the 3D contour on thin-walled supports, for example, automobile body sheet parts, frames, window casings, doors, or other outer skin-like 3D contours is to be possible. That (is), under the condition that there is not even any supplemental security adhesion, whereby a high sealing quality with high reproducibility of mounting precision is to be guaranteed.

This objective is accomplished according to an installation process with the features of claim 1 as well as an associated fastening system with the features of claim 6.

The dependent claims relate to specific operations and embodiments of the fastening system.

On the basis of the device, the fastening system of the invention provides for a method for installing hollow chamber profiles on thin-walled sheets without using adhesives. It makes possible a purely mechanical mounting-clamping-of sealing, damping and slot-filling profiles or other supports having an outer skin-like 3D contour on motor vehicles.

Even small differences in distances in connection with perorations in the support and/or in the sealing element or the clamping strip can, in this case, be compensated for by using a rubber elastic sealing element material.

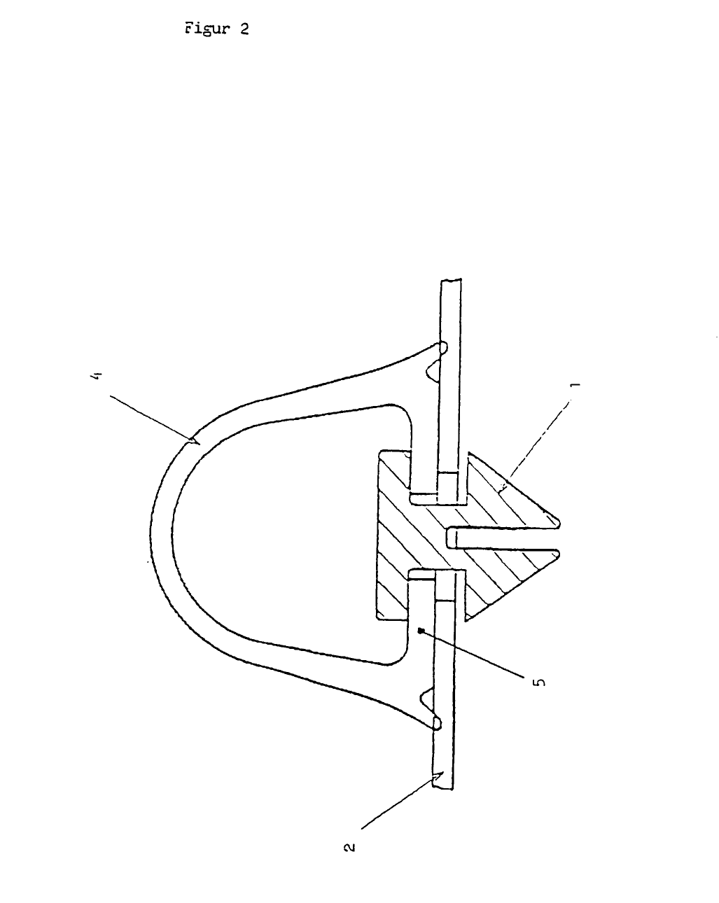

FIG. 2 shows a fastened sealing element designed as a hollow chamber profile in which the fastening chip remains concealed to the observer of the sealing element in the fastened state. Nonetheless, it is disadvantageous that contour adaptation and contact pressure remain very uneven over the length of the sealing element or the sealing track. Detaching the fastening is only possible with a destruction of the clip or the sealing element. If the remainder of the clip is lost, it gets into the hollow spaces which can later lead to unpleasant driving noises.

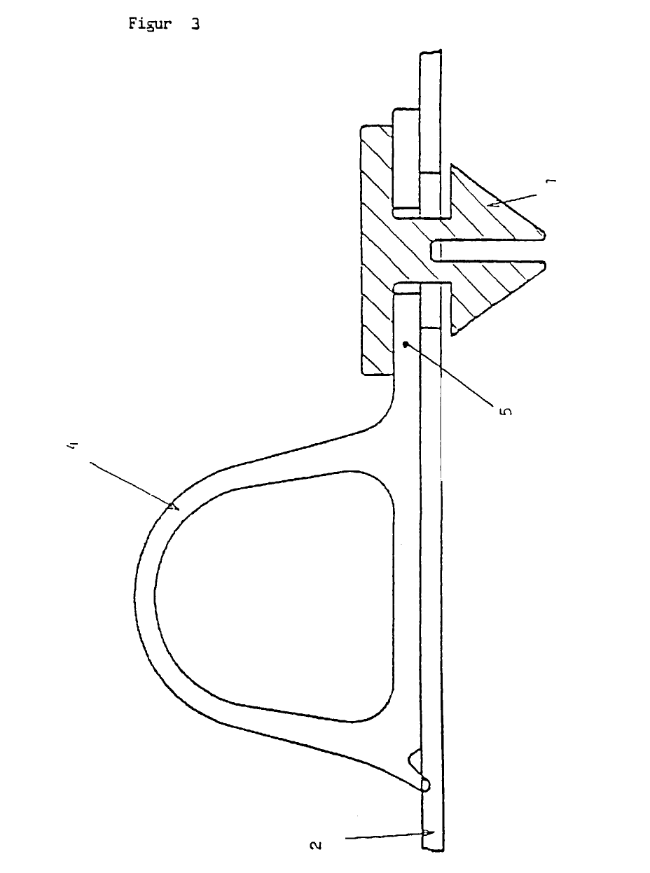

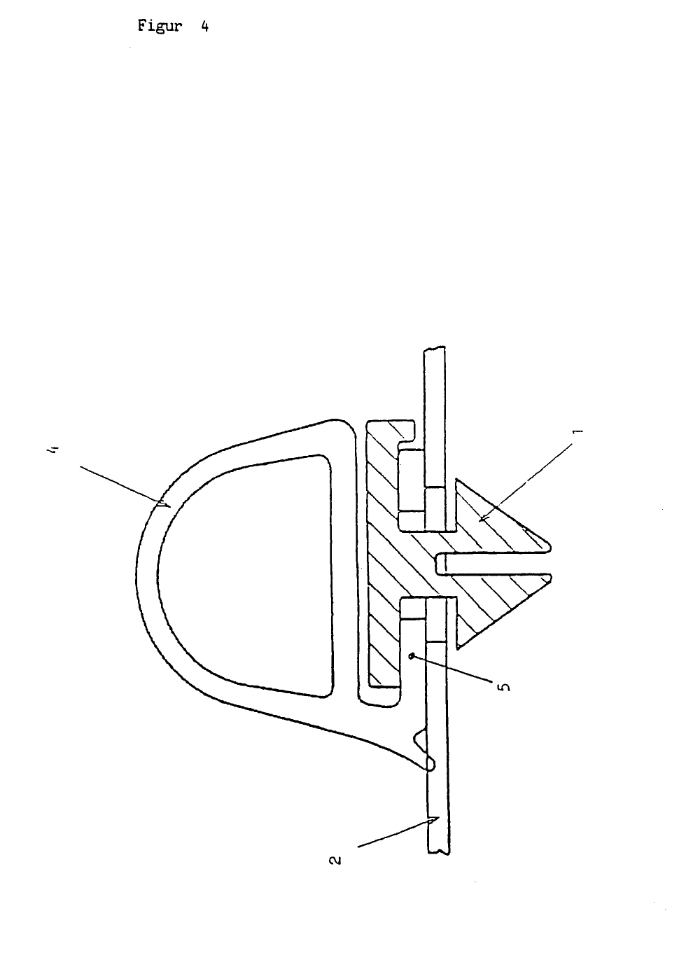

FIGS. 3 and 4 likewise show a hollow chamber-like, cord-like sealing element in which the fastening takes place without a penetration of a fastening element into the hollow chamber. Some disadvantages are avoided with this type of mounting. Others such as, for example, the instability of the sealing zone, are considerable.

Both are also an example for the clip strip system. In the figures, it relates to the fact that the elastic element is fixed on the support using a clip strip. The section representation does not make the clip strip curve clear.

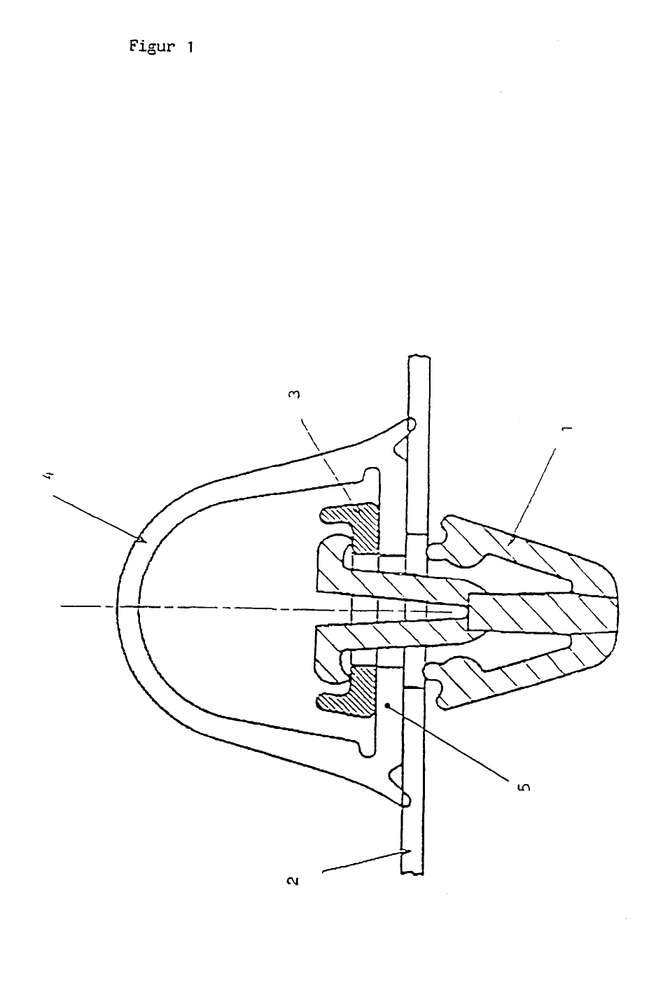

FIG. 1 shows the design of the invention in the installed state.

Moreover, the elastic sealing element 4 is advantageously used as a fastening joining element by means of a punched cover strip 3 as clamp strip and a plastic clip 1 known from DE 195 00 231 A1 as fastening joint element. The clamp strip 3 visible only in a section is moreover designed as adapted to the contour curve of the automobile body and lies on the side of the clamping bar 5 facing away from support 2.

In this way, a continuous fit of the sealing element 4 on the support 2 is possible, whereby the one-piece clip 1 is present as a fastening joint element of the fastening system as an individual element and is not materially incorporated into a one-piece clip strip.

There is an advantageous correspondence with the design in that the fastening system (as in FIG. 2) is not visible to the observer of the motor vehicle in the installed state of the sealing element.

Clip constructions as in FIGS. 2, 3 and 4 can moreover by all means also be used in a fastening system of the invention and be installed according to the method of the invention if a sufficient mounting force can be built up between the spreading bars of the clips and the support.

### REFERENCE NUMBER LIST

1 Clip

2 Support, for example auto body sheet

3 Clamp strip, for example punched strip cover

4 Sealing element, for example hollow chamber profile

5 Clamping frame of the sealing element

We claim:

1. Method for mounting a rubber elastic, hollow chamber-like sealing element (4) on a thin-walled support (2) with a 3D contour along a defined clamping path, whereby support and sealing element have holes at specific distances and the fastening takes place by means of clips (1) which have spreading pegs and are in any given case inserted into a hole of the support and a hole of the sealing element allocated thereto, characterized in that prior to fastening the sealing element (4) on the support (2) into the interior of the hollow chamber profile of the sealing element (4) on the surface of the clamping bar (5) of the sealing element (4) facing away from the support (2), a clamp strip (3) likewise provided with holes is provided, whereby for fastening, each clip (1) then additionally penetrates the allocated hole in the clamp strip (3), and the clamp strip (3) is incorporated by releasing the spreading pegs into the clamping interlocking system.I.

2. Method according to claim 1, characterized in that the clamp strip (3) is constructed of several pieces and each component piece has at least two holes.

3. Method according to claims 1 or 2, characterized in that the clamp strip (3) is adapted to each available 3D contour of the fastening section allocated to it prior to installation.

4. Process according to one of claims 1 to 3, characterized in that the clamp strip (3) is designed in several pieces, whereby each component piece is already adapted to the respective 3D contour of the fastening section allocated to it before installation.

5. Fastening system for clamping rubber elastic, hollow chamber-like sealing elements (4) on a thin-walled support (2) with a 3D contour, whereby support and sealing element have holes at specified distances, through which clips (1) for fastening in any given case provided with spreading pegs that can be inserted, characterized in that a clamp strip (3) having holes is arranged as a support for the spreading pins of the clips (1) in the interior of the hollow chamber profile of the sealing element (4) on the side of the clamp bar (5) of the sealing element (4) facing away from the support (2).

6. Fastening system according to claim 5, characterized in that the clamp strip (3) consists of component pieces which can be arranged one after the other which in any given case have at least two holes.

7. Fastening system according to one of claims 5 to 6, characterized in that the clamp strip (3) or component pieces of it are adapted to the respective 3D contour of the allocated fastening section.
